(19) United States
(12) Patent Application Publication
(10) Pub. No.: US 2020/0006984 A1
(43) Pub. Date: Jan. 2, 2020

(54) SWIMMING ROBOT AND DISPLAY APPARATUS FOR CHARGING SAME

(71) Applicant: LG ELECTRONICS INC., Seoul (KR)

(72) Inventors: Hyong Guk KIM, Seoul (KR); Hyoung Mi KIM, Seoul (KR); Seung Jong PARK, Gyeonggi-do (KR); Yu June JANG, Seoul (KR)

(21) Appl. No.: 16/567,631

(22) Filed: Sep. 11, 2019

Related U.S. Application Data
(63) Continuation of application No. PCT/KR2019/005159, filed on Apr. 29, 2019.

(51) Int. Cl. H02J 50/10; H02J 7/02; H02J 50/90; B63G 8/00

(52) U.S. Cl. CPC H02J 50/10; H02J 7/025; A01K 63/006; B63G 8/001; H02J 50/90

(57) ABSTRACT

Disclosed is a display apparatus having a water tank in which one or more swimming robots are located. This apparatus includes communicator for communicating with the swimming robot or a mobile terminal, a display for displaying a video, one or more sensors, a wireless power transmitter which is located on an inner wall of the water tank and which includes a plurality of arranged transmission coils, and a controller. Accordingly, a display apparatus and a swimming robot which have artificial intelligence and which perform 5G communication may be provided. As a result, a charging efficiency can be improved, and a user's convenience can be further improved.

### CROSS-REFERENCE TO RELATED APPLICATION

This application is a continuation application of PCT Patent Application No. PCT/KR2019/005159, entitled “Swimming robot and display apparatus for charging same,” filed on Apr. 29, 2019, in the World Intellectual Property Organization, the entire disclosure of which is incorporated herein by reference.

### BACKGROUND

### 1. Field of the Invention

The present disclosure relates to a swimming robot located in a water tank, and a display apparatus for charging the swimming robot.

### 2. Description of Related Art

In general, an aquarium may provide an environment which is inhabited by a variety of aquatic organisms, such as fish, aquatic plants, and the like, thereby providing people who are looking at the aquarium with a sense of emotional security, and providing a resting place with a comfortable atmosphere in a person's residential and cultural life. However, since the objects to be looked at are living organisms, it is essential to manage the aquarium periodically. Accordingly, a significant amount of cost, time, and attention is required in managing, maintaining, and repairing the aquarium. For this reason, an artificial fish robot has been developed, as an alternative to the living organisms in an aquarium.

Korean Patent Application Publication No. 20120127896A, entitled “Robot Fish and Artificial Aquarium Thereof” (hereinafter referred to as “Related Art 1”), discloses an artificial aquarium having a solar cell to provide power to robot fish.

However, the above-mentioned artificial aquarium requires separate equipment for concentrating sunlight, there is a restriction on a place for concentrating the sunlight, and the efficiency is also not high.

Korean Patent Application Publication No. 20160124568A, entitled “Apparatus for Transmitting Wireless Power and Control Method Thereof” (hereinafter referred to as “Related Art 2”), discloses a wireless power transmission apparatus which includes a plurality of power transmission units, and which transmits, through a specified power transmission unit, wireless power to a power reception unit disposed at a specific position.

However, regarding the above-mentioned wireless power transmission apparatus, it is difficult to transmit the wireless power to a moving object.

### SUMMARY OF THE INVENTION

The present disclosure is directed to providing a display apparatus capable of monitoring movement of a swimming robot which is swimming, and charging the swimming robot.

The present disclosure is further directed to providing a display apparatus having a water tank capable of wirelessly charging a swimming robot in water.

The present disclosure is still further directed to providing a display apparatus capable of suitably selecting, depending on the situation, any one of wireless power transmission in a magnetic resonance scheme and wireless power transmission in a magnetic induction scheme that is sensitive to a distance difference between a power transmission unit and a power reception unit.

The present disclosure is still further directed to providing a display apparatus having a user-friendly water tank capable of enabling interaction between a user terminal and a swimming robot.

The present disclosure is not limited to what has been disclosed hereinabove. A person skilled in the art may clearly understand, from the following description, other aspects not mentioned above.

According to an embodiment of the present disclosure, a display apparatus having a water tank in which one or more swimming robots are located may include a wireless power transmission unit that is located on an inner wall of the water tank and includes a plurality of transmission coils arranged in a predetermined pattern, and a control module.

When the swimming robot approaches to within a charging range of the wireless power transmission unit, the control module may select a transmission coil to transmit wireless power to the swimming robot, and control the wireless power transmission unit such that the wireless power transmission unit transmits wireless power to a reception coil of the swimming robot using the selected transmission coil. Accordingly, the display apparatus having the water tank may transmit the wireless power to a moving swimming robot having a wireless power reception unit.

According to one embodiment of the present disclosure, a swimming robot may include a swimming structure unit disposed inside the swimming robot in a watertight manner, configured to drive the movement of the swimming robot in water.

According to one embodiment of the present disclosure, a display apparatus having a water tank may include a plurality of transmission coils, wherein some of the plurality of transmission coils may be arranged in a row in a horizontal direction on a first charging surface disposed on one surface of the inner wall of the water tank, and some of the plurality of transmission coils may be arranged on a second charging surface which abuts against the first charging surface and extends to protrude from the first charging surface to the inside of the water tank in order to support a swimming robot thereon.

Here, the transmission coils arranged on the first charging surface may transmit the wireless power in a magnetic resonance scheme, and the transmission coils arranged on the second charging surface may transmit the wireless power in a magnetic induction scheme.

According to one embodiment of the present disclosure, a display apparatus having a water tank may include a communication unit for communicating with a swimming robot or a mobile terminal, a display for displaying a video, one or more sensing units, and a control module, wherein the control module may receive information on a specific video displayed on the mobile terminal through the communication unit and then display the specific video on the display, and when one or more pieces of video feature information on the specific video displayed on the mobile terminal are received from the mobile terminal through the communication unit, control the swimming robot such that the swimming robot applies the video feature information.

The present disclosure is not limited to what has been disclosed hereinabove. A person skilled in the art may clearly understand, from the following description, other aspects not mentioned above.

According to various embodiments of the present disclosure, the following effects can be obtained.

Firstly, a swimming robot having a wireless power reception unit and which is capable of receiving wireless power even while swimming may be provided.

Secondly, any one of wireless charging in a magnetic induction scheme, which has a good charging efficiency but has a dependence on distance, and wireless charging in a magnetic resonance scheme, which has a lower charging efficiency but has a low dependence on distance, may be selectively performed, so that the charging efficiency can be improved.

Thirdly, a display apparatus capable of enabling user-friendly interaction may be provided, so that user-friendliness and a user's convenience can be improved.

### BRIEF DESCRIPTION OF DRAWINGS

FIG. 1 is a view showing an external appearance of a swimming robot having light emitting elements according to one embodiment of the present disclosure.

FIG. 2 is a view showing an external appearance of a swimming robot having a flexible display according to one embodiment of the present disclosure.

FIG. 3 is a block diagram showing a configuration of the swimming robot according to one embodiment of the present disclosure.

FIG. 4 is a view showing a display apparatus having a water tank capable of interacting with both the swimming robot and a user, according to one embodiment of the present disclosure.

FIG. 5 is a block diagram showing a configuration of the display apparatus for charging the swimming robot according to one embodiment of the present disclosure.

FIG. 6 is a view illustrating the concept of transmitting power wirelessly from the display apparatus (also referred to as a wireless power transmission apparatus) to the swimming robot (also referred to as an electronic device) in an inductive coupling scheme.

FIGS. 7 and 8 are block diagrams showing partial configurations of the wireless power transmission apparatus and the electronic device to which an electromagnetic induction scheme is applicable, according to one embodiment of the present disclosure.

FIG. 9 is a block diagram of the wireless power transmission apparatus including one or more transmission coils for transmitting power in an inductive coupling scheme according to one embodiment of the present disclosure.

FIG. 10 is a view illustrating the concept of transmitting the power wirelessly from the wireless power transmission apparatus to the electronic device in a resonant coupling scheme.

FIGS. 11 and 12 are block diagrams respectively showing partial configurations of the wireless power transmission apparatus and the electronic device to which a resonance scheme is applicable, according to one embodiment of the present disclosure.

FIG. 13 is a block diagram of the wireless power transmission apparatus configured to include the one or more transmission coils for transmitting power in another resonant coupling scheme according to one embodiment of the present disclosure.

FIGS. 14 to 17 are views showing the display apparatus having the water tank on which transmission coils are arranged, according to various embodiments of the present disclosure.

FIGS. 18 and 19 are views showing the swimming robot receiving wireless power from a wireless power transmission unit on which a first charging surface and a second charging surface shown in FIG. 17 are disposed.

FIGS. 20 and 21 are views showing the display apparatus having the water tank capable of interacting with both the swimming robot and a mobile terminal, according to one embodiment of the present disclosure.

### DETAILED DESCRIPTION

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be connected with the other element or intervening elements may also be present. In contrast, when an element is referred to as being “directly connected with” another element, there are no intervening elements present.

A singular representation may include a plural representation unless it represents a definitely different meaning from the context. Terms such as “include” or “has” are used herein and should be understood that they are intended to indicate an existence of several components, functions or steps, disclosed in the specification, and it is also understood that greater or fewer components, functions, or steps may likewise be utilized.

Hereinafter, the embodiments disclosed in this specification will be described in detail with reference to the accompanying drawings. In the following description and drawings, the same reference numbers refer to the same components. Only the difference with respect to individual embodiment is described. In addition, in the following description of the embodiments disclosed in this specification, the detailed description of related known technology will be omitted when it may obscure the subject matter of the embodiments according to the present disclosure.

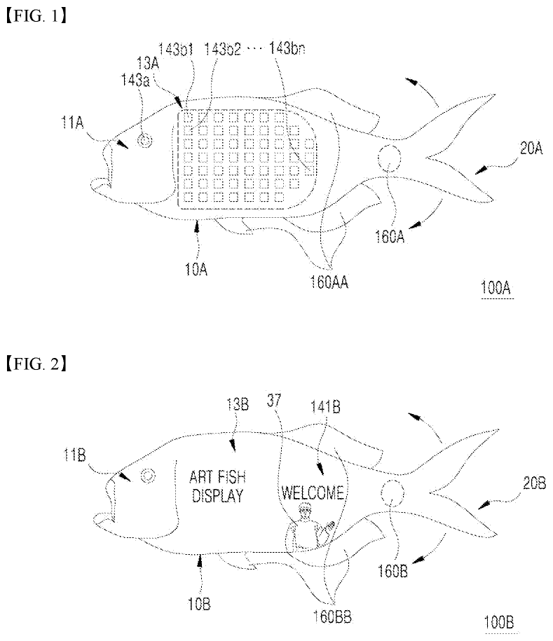

FIGS. 1 and 2 show an external appearance of swimming robots 100A and 100B according to various embodiments of the present disclosure, respectively. The swimming robot may be a robot that swims in water, and may swim in a small fish tank, a large aquarium, a river, the sea, or the like.

Specifically, FIG. 1 shows the external appearance of the swimming robot 100A having light emitting elements according to one embodiment of the present disclosure.

The swimming robot 100A includes a body portion 10A and a tail portion 20A. A swimming structure unit 160 is disposed between the body portion 10A and the tail portion 20A, and the tail portion 20A is moved repeatedly left and right or up and down by the swimming structure unit 160, so that the swimming robot 100A may swim.

Since the swimming structure unit 160 is disposed inside the swimming robot 100A and does not protrude to the outside, a fluid resistance of the swimming robot 100A, which is a swimming object, may be reduced, and the swimming robot 100A may move easily to a desired position. However, the arrangement of the swimming structure unit 160 is not limited to the position 160A indicated in FIG. 1, and may include various internal structures and external structures 160AA for allowing the swimming robot 100A to freely move in vertical and horizontal directions.

In addition, the body portion 10A may include a head 11A and a body section 13A, and a first light emitting element 143a representing an eye may be disposed on the head 11A. A plurality of first light emitting elements 143a corresponding to left and right eyes of the swimming robot 100A may be implemented. However, the eye of the swimming robot 100A may not be made of the light emitting element, but may instead be made of various materials that may be recognized by a user, or may be omitted.

A plurality of second light emitting elements 143b1 to 143bn may be arranged on the body section 13A of the body portion 10A, and the plurality of second light emitting elements 143b1 to 143bn may be implemented as micro light emitting diodes (LEDs) having a size of 10 to 100 micrometers, respectively, or may be implemented as mini LEDs having a size of 100 to 200 micrometers, respectively. However, although tens of LEDs are shown as being arranged in FIG. 1, tens of thousands of LEDs may be arranged on the body section 13A depending on the size of the LED, and the LED may also be arranged on an area other than the body section 13A at the time of implementation.

FIG. 2 shows the external appearance of the swimming robot 100B having a flexible display according to one embodiment of the present disclosure. Contents that overlap with those described in FIG. 1 will be omitted in the following description of FIG. 2.

The swimming robot 100B may include a flexible display 141B, which forms an overall exterior of a body portion 10B. That is, the flexible display 141B may form both a head 11B and a body section 13B which together constitute the body portion 10B. Although the flexible display 141B is described as forming the body portion 10B without being bent, according to an embodiment, the flexible display 141B is integrally formed so as to include a tail portion 20B, and the tail portion 20B may be implemented to repeatedly bend and straighten when the swimming robot 100B swims.

When the flexible display 141B forms the body portion 10B, all of the eye, gills, an air bladder, and the like on the head 11B may be displayed as a video on the flexible display 141B. In addition, the swimming robot 100B may display various phrases (for example, “ART FISH DISPLAY”) and videos 37 on the flexible display 141B.

When the flexible display 141B is applied to the swimming robot 100B, an organic light emitting diode (OLED), a micro LED, and a mini LED may be mounted on a light source module within the swimming robot 100B, and a configuration including a driving circuit for causing each pixel of the flexible display 141B to display an appropriate color may be included in the swimming robot 100B.

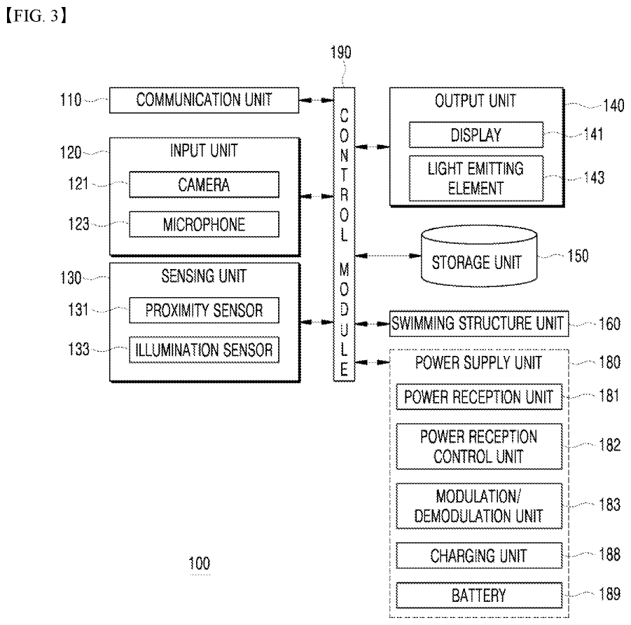

FIG. 3 is a block diagram showing a configuration of the swimming robot 100 according to one embodiment of the present disclosure. The swimming robot 100 may include a communication unit 110, an input unit 120, a sensing unit 130, an output unit 140, a storage unit 150, a swimming structure unit 160, a power supply unit 180, and a control module 190. Since the components shown in FIG. 3 are not essential for implementing the swimming robot 100, the swimming robot 100 disclosed herein may have more or fewer components than those listed above.

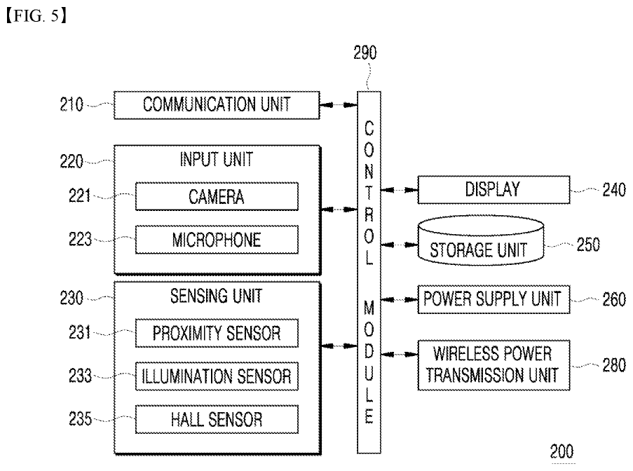

More specifically, the communication unit 110 among the above described components may include one or more wired or wireless communication modules which enable communication between the swimming robot 100 and a mobile terminal, between the swimming robot 100 and a display apparatus (200 in FIG. 5) having a water tank, and between the swimming robot 100 and an apparatus having a communication module. In some implementations, the communication unit 110 may be implemented a communicator. In some implementations, the communication unit 110 comprises at least one of a communicator or consists of at least one of a communicator.

The input unit 120 may include a camera 121 or a video input unit from which the input unit 120 receives a video signal, a microphone 123 or an audio input unit from which the input unit 120 receives an audio signal, a code input unit 125 for receiving a bar code or a quick response (QR) code, and a user input unit (for example, a touch key or a mechanical key) for receiving information from a user. Voice data or image data collected by the input unit 120 may be analyzed and then processed as a user's control command. In some implementations, input unit 120 may be implemented inputter or input interface. In some implementations, input unit 120 comprises at least one of inputter or consists of at least one of inputter. In some implementations, input unit 120 may be configured to input data and signals.

The sensing unit 130 may include one or more sensors for detecting at least one of information related to the swimming robot 100 itself, information on the surrounding environment the swimming robot 100, or user information. For example, the sensing unit 130 may include at least one of a proximity sensor 131, an illumination sensor 133, a touch sensor, an acceleration sensor, a magnetic sensor, a gravitational sensor (G-sensor), a gyroscope sensor, a motion sensor, an RGB sensor, an infrared sensor (IR sensor), a finger scan sensor, an ultrasonic sensor, an optical sensor (see, for example, the camera 121), a microphone (see the microphone 123), a battery gauge, an environment sensor (for example, a barometer, a hygrometer, a thermometer, a radiation sensing sensor, a heat sensing sensor, or a gas sensing sensor), or a chemical sensor (for example, an electronic nose, a healthcare sensor, or a biometric sensor). The swimming robot 100 disclosed herein may also combine and utilize information detected by at least two sensors among the sensors described above. The sensing unit 130 comprises at least one of a sensor.

The sensing unit 130 may detect, by using various sensors, a user behavior and an event occurring on the display apparatus (200 in FIG. 5) having the water tank. The user behavior may simply involve approaching the water tank, performing a specific motion, or the like.

The output unit 140 is for generating an output such as a visual output, an audible output, or a haptic output, and may include at least one of a display 141, one or more light emitting elements 143s, a sound output unit, or a haptic module. Since the display 141 may form a mutually layered structure with the touch sensor or may be formed integrally with the touch sensor, the display 141 may be implemented as a touch screen. This touch screen may function as a user input unit for providing an input interface between the swimming robot 100 and the user, and at the same time may provide an output interface between the swimming robot 100 and the user. The output unit 140 comprises at least one of a outputter or consists of at least one of a outputter. The outputter may be configured to output data and signal.

Here, the display 141 may include both a flat display and the flexible display, and the flexible display may be applied to form both the body portion 10B and the tail portion 20B of the swimming robot 100, or may be applied to form only the body portion 10B.

The storage unit 150 stores data for supporting various functions of the swimming robot 100. The storage unit 150 may store a number of application programs (or applications) executed in the swimming robot 100, data for operating the swimming robot 100, and instructions. At least some of these application programs may be downloaded from an external server through a wireless communication. In addition, the storage unit 150 may store user information required to perform the interaction with the swimming robot 100. The user information may be used to identify who a recognized user is. The storage unit 150 comprises at least one of a storage.

The swimming structure unit 160 includes an electrical or mechanical structure unit for driving the movement of the swimming robot 100 in water. The swimming structure unit 160 may include electrical or mechanical equipment for providing swimming power, disposed between the body portion and the tail portion of the swimming robot 100, and may include equipment such as a fin, for enabling easy swimming. The swimming structure unit 160 comprises at least one of a swimming structure or consists of at least one of a swimming structure.

Under the control of the control module 190, the power supply unit 180 is supplied with external power or internal power, and supplies power to each component of the swimming robot 100. This power supply unit 180 includes a battery, which may be an internal battery or a replaceable battery. The battery may be charged in a wired charging scheme or a wireless charging scheme, wherein the wireless charging scheme may include a magnetic induction scheme or a magnetic resonance scheme. The power supply unit 180 comprises at least one of a power supplier.

The control module 190 performs the wired charging scheme or the wireless charging scheme according to a user input or an internal input. Here, the internal input is a signal indicating that an induced current generated in a secondary coil of a terminal has been detected.

A power reception unit 181 is a module for receiving a wireless power signal and a power reception control unit 182 of the power supply unit 180 may be implemented to be included in the control module 190. In this specification, the operation of the power reception control unit 182 is performed by the control module 190. A modulation/demodulation unit 183 modulates the wireless power signal by changing a load impedance.

In addition, the power supply unit 180 receives external power and/or internal power under the control of the control module 190, and supplies power required for operation of each component. The power supply unit 180 may include a battery 189 that supplies the power to each component of the swimming robot 100, and may include a charging unit 188 for charging the battery 189 by wire or wirelessly.

When it is determined, based on information detected by the sensing unit 130 or information input through the input unit 120, that a user command has been inputted, the control module 190 may control the swimming robot 100 such that the swimming robot 100 performs a movement corresponding to the inputted user command. In some implementations, the control module 190 may be implemented a controller. In some implementations, the control module 190 comprises at least one of a controller or consists of at least one of a controller.

As one example, the control module 190 may detect a user through the sensing unit 130 when the user approaches, control the swimming structure unit 160 such that the swimming robot 100 swims in a specific pattern, control the light emitting element 143 such that the light emitting element 143 emits a specific pattern, and control the display 141 such that the display 141 displays a specific video or phrase.

In addition, the control module 190 may recognize the user command included in the user's speech, and may control the light emitting element 143 such that the light emitting element 143 emits a light emitting pattern corresponding to the user command, or display a video corresponding to the user command on the display 141.

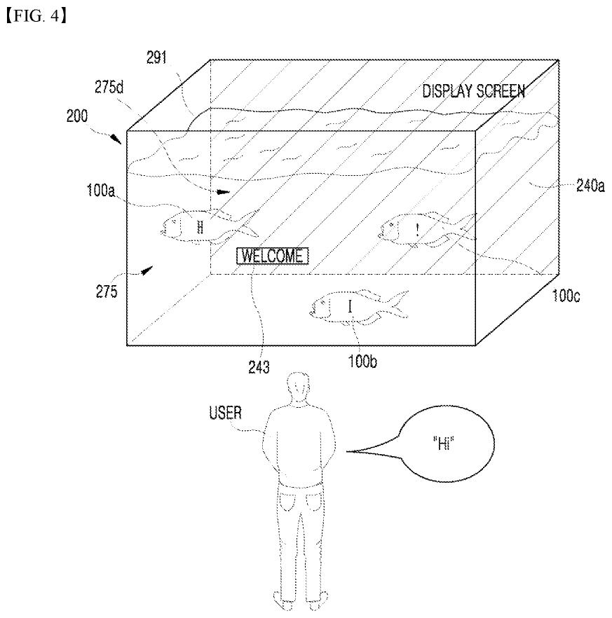

FIG. 4 is a view showing a display apparatus 200 having a water tank according to various embodiments of the present disclosure.

FIG. 4 shows the display apparatus 200 having the water tank 275 in which the swimming robots 100a and 100b are located, wherein a flat display 240a is applied to the display apparatus 200. The water tank 275 may be formed in a hexahedron shape, and a display 240a for displaying a video may be disposed on one surface of the water tank 285. The water tank may be implemented as a small fish tank, a large aquarium, or the like.

In addition, the swimming robots 100a to 100c are swimming in the water tank 275, and the inside of the water tank 275 may be filled with liquid. The liquid may be common water. However, the liquid to be filled in the water tank 275 may include water mixed with distilled water, Clorox® or vinegar, or ethanol for disinfection, and when there is no possibility of ingestion by a human, water mixed with Clorox®, colorless and inviscid liquid such as liquid paraffin, or antiseptic such as phenoxyethanol, or the like.

The display apparatus 200 may provide the display 240a on one surface 285a of the water tank 275, and the display 240a may interact with both the user and the swimming robots 100a to 100c, wherein the display apparatus 200 may communicate with the swimming robots 100a to 100c and control the swimming robots 100a to 100c such that the swimming robots 100a to 100c are driven to perform a specific movement or a specific output.

The user is looking at the water tank 275, and the first swimming robot 100a may detect the approach of the user, photograph the user using the photographing unit, recognize the photographed user based on previously stored user information when the photographed video signal is inputted through the input unit, and perform driving corresponding to the recognized user.

For example, when the user approaches the first swimming robot 100a at a close distance, the first swimming robot 100a may swim in a predetermined pattern and emit a specific light emitting pattern by means of the light emitting element.

The display apparatus 200 may recognize a specific user command (for example, “Hi”). The display apparatus 200 may include the input unit 220, such as the microphone 223, to detect the voice of the user, and may recognize the user command through the voice.

In this case, the display apparatus 200 may display the phrase “WELCOME” 243 or display various videos on the display, and may control each of the swimming robots 100a to 100c to display the letters “H”, “I”, and “!”, respectively.

Specifically, the display apparatus 200 may communicate with each of the swimming robots 100a to 100c individually to cause each of them to display a specific phrase, and may display a specific video instead of the specific phrase on the display of each of the swimming robot 100a to 100c, according to the implementation.

In addition, the display apparatus 100 may control each of the swimming robots 100a to 100c individually to transmit commands relating to various clustering methods to each of the swimming robots 100a to 100c, thereby providing various visual effects.

FIG. 5 is a block diagram showing a configuration of the display apparatus 200 having the water tank in which one or more swimming robots are located, according to one embodiment of the present disclosure.

Referring to FIG. 5, the display apparatus 200 includes a communication unit 210, an input unit 220, a sensing unit 230, a display 240, a storage unit 250, a power supply unit 260, a wireless power transmission unit 280, and a control module 290. Since the components shown in FIG. 5 are not essential for implementing the display apparatus 200, the display apparatus 200 described herein may have more or fewer components than those listed above. In addition, in describing FIG. 5, description of the same or similar contents as those of FIG. 3 may be omitted.

The communication unit 210 may communicate with the swimming robot 100 or the mobile terminal. Here, the mobile terminal may be included within the control range of the user. The communication unit 210 may include a module that supports Bluetooth®, ZigBee, Ultra Wide Band (UWB), wireless USB, Near Field Communication (NFC), wireless LAN, and the like. The wireless power transmission unit 280 comprises at least one of a wireless power transmitter or consists of at least one of a wireless power transmitter.

The sensing unit 230 may include a sensor for detecting the position of the swimming robot 100, and the detected position information may be used to allow the wireless power transmission unit 280 to efficiently transmit power.

For example, in the case of wireless power transmission according to the embodiments that support the inductive coupling scheme, the sensing unit 230 may operate as a position detection unit, and the position information detected by the sensing unit 230 may be used to move or rotate a transmission coil 2811a within the wireless power transmission unit 280.

In addition, for example, the display apparatus 200 including one or more transmission coils according to the above-described embodiments may determine, based on the position information of the swimming robot 100, the coils among the one or more transmission coils which may establish an inductive coupling relationship or a resonant coupling relationship with a reception coil of the swimming robot 100.

The sensing unit 230 may be configured to monitor whether the swimming robot 100 is approaching a chargeable area. The function of the sensing unit 230 for detecting whether the swimming robot is approaching may be performed separately or in combination with the function of a power transmission control unit 282 in the power transmission unit 280 for detecting whether the electronic device 100 is approaching.

The display 240 may be an area for displaying the video, use various types of displays in addition to the flat display, and be disposed on a plurality of surfaces in addition to a specific one surface of the water tank.

The control module 290 may recognize a user command in an audio signal inputted through the input unit 220, and control the swimming robot 100 such that the swimming robot 100 performs driving corresponding to the user command. Here, “control” may mean transmission of a control command to the swimming robot 100 by the display apparatus 200.

For example, when the user speaks “Hi”, the control module 290 may recognize the user command in the audio signal inputted through a microphone 223. The control module 290 may recognize a predetermined user command in the user's speaking of “Hi”, and cause the swimming robot 100 to display a specific video or a specific phrase on the display 140 thereof.

The control module 290 may control the movement of the swimming robot 100 through the communication unit 210. The control module 290 may provide information on each point (or pixel) of the display 240 to the swimming robot 100, and provide three-dimensional spatial information on each point of the water tank to the swimming robot 100 in order to control the swimming robot 100 such that the swimming robot 100 moves to a specific point of the water tank.

The control module 290 may receive color information and shape information (including size information, form information, and the like) on the swimming robot 100 through the communication unit 210, and may select, on the video displayed on the display 240, an item area based on the color information and the shape information on the swimming robot. That is, the control module 290 may select the item area corresponding to the color and shape of the swimming robot on the display 240.

In this case, the control module 290 may control the swimming robot 100 such that the swimming robot 100 moves to the selected item area, and the control module 290 may provide position information on the item area to the swimming robot 100.

When the swimming robot 100 moves to the selected item area, the control module 290 may control the swimming robot 100 such that the swimming robot 100 reflects the color information and the shape information on the item. That is, the control module 290 may cause the swimming robot 100 to reflect the color information and the shape information (including the size information and the form information) on a specific portion of the display 240.

As a result, the swimming robot 100 is driven such that, from the perspective of the user, the swimming robot 100 appears to come out of the display 240. In this way, interaction between the user, the swimming robot, and the display 240 may take place.

In this case, the control module 290 may cause the item area applied to the swimming robot 100 to disappear from the video on the display 240. As a result, the effect of the swimming robot 100 appearing to come out of the display 240 can be more prominent to the user.

Here, the video displayed on the display 240 may be a video received from the mobile terminal through the communication unit 210. Accordingly, interaction between the mobile terminal and the display apparatus 200 may take place.

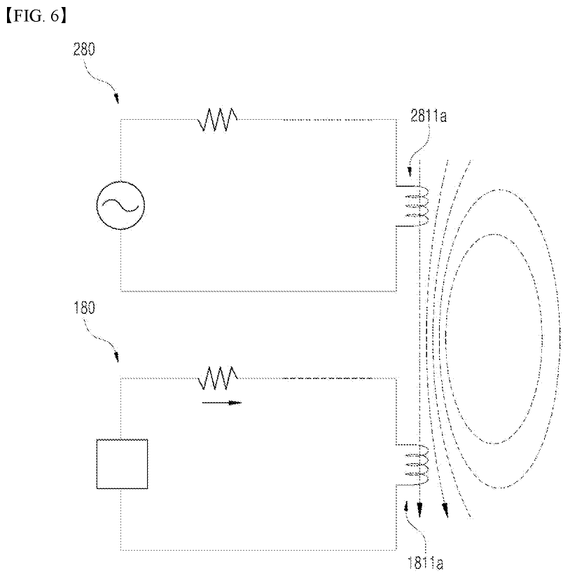

FIGS. 6 to 13 are views illustrating the magnetic induction scheme and the magnetic resonance scheme according to one embodiment of the present disclosure. First, FIGS. 6 to 9 are views illustrating the wireless charging in the magnetic induction scheme, and FIGS. 10 to 13 are views illustrating the wireless charging in the magnetic resonance scheme. In describing these, the display apparatus 200 will be referred to as a wireless power transmission apparatus, and the swimming robot 100 will be referred to as an electronic device.

FIG. 6 illustrates the concept of transmitting the power wirelessly from the wireless power transmission apparatus 200 to the electronic device 100 according to the embodiments that support the inductive coupling scheme.

When the wireless power transmission apparatus 200 transmits the power in the inductive coupling scheme, as an intensity of current flowing through a primary coil in the wireless power transmission unit 280 changes, a magnetic field passing through the primary coil also changes depending on the changed current. This changed magnetic field generates an induced electromotive force at a secondary coil in the power supply unit 180 of the electronic device 100.

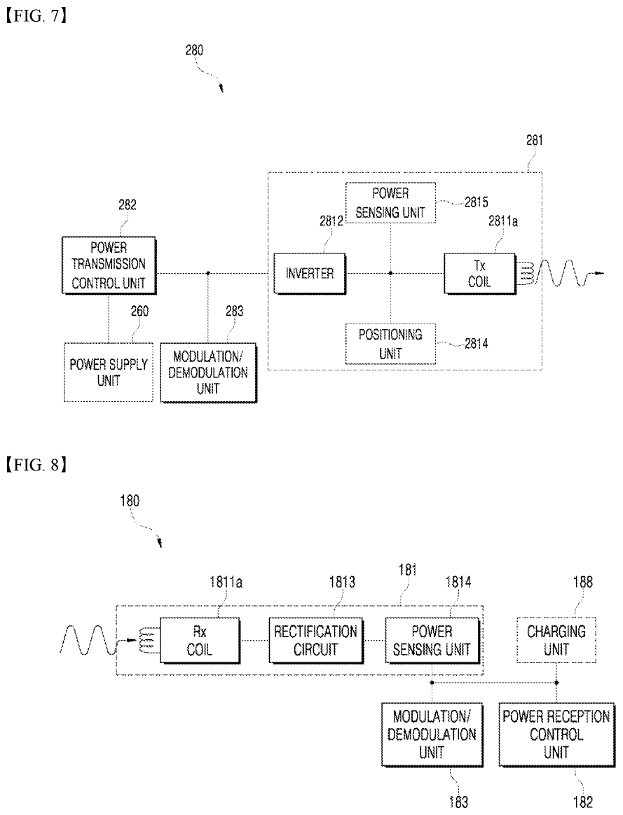

According to this method, a power conversion unit (281 in FIG. 7) of the wireless power transmission apparatus 200 is configured to include a transmission coil (Tx coil) 2811a that operates as the primary coil in the magnetic induction. In addition, the power reception unit (181 in FIG. 8) of the electronic device 100 is configured to include a reception coil (Rx coil) 1811a that operates as the secondary coil in the magnetic induction.

First, the wireless power transmission apparatus 200 and the electronic device 100 are arranged such that the transmission coil 2811a of the wireless power transmission apparatus 200 and the reception coil 1811a of the electronic device 100 are close to each other. Thereafter, when the power transmission control unit 282 controls the current of the transmission coil 2811a such that the current changes, the power reception unit 181 is controlled so as to supply the power to the electronic device 100 using the induced electromotive force in the reception coil 1811a.

The efficiency of the wireless power transmission by the inductive coupling scheme has a small dependence on a frequency characteristic, but has a great dependence on the alignment of and the distance between the wireless power transmission apparatus 200 and the electronic device 100, each including the coil.

In order to transmit the wireless power in the inductive coupling scheme, the wireless power transmission apparatus 100 may also be configured to include an interface surface (not shown) in the form of a flat surface.

One or more electronic devices may be disposed on the interface surface, and the transmission coil 2811a may be mounted below the interface surface. In this case, the vertical spacing between the transmission coil 2811a mounted below the interface surface and the reception coil 1811a of the electronic device 100 disposed on the interface surface is small, so that the distance between the coils may be small enough to effectively transmit the wireless power in the inductive coupling scheme.

In addition, an alignment indication unit (not shown) for indicating a position where the electronic device 100 is to be disposed may be formed on the interface surface. The alignment indication unit indicates the position of the electronic device 100 for achieving a suitable alignment between the transmission coil 2811a mounted below the interface surface and the reception coil 1811a. In some embodiments, the alignment indication unit may be a simple mark. In other embodiments, the alignment indication unit may be formed as a protruding structure to guide the position of the electronic device 100. In addition, in still other embodiments, the alignment indication unit may be formed as a magnetic body, such as a magnet, mounted below the interface surface, so that the alignment unit may guide the coils to achieve an appropriate alignment by mutual attraction with a magnetic body of different polarity mounted inside the electronic device 100.

The wireless power transmission apparatus 200 may also be formed to include one or more transmission coils. The wireless power transmission apparatus 200 may increase a power transmission efficiency by selectively using some of the one or more transmission coils which are suitably aligned with the reception coil 1811a of the electronic device 100.

Hereinafter, the configurations of the wireless power transmission apparatus 200 and the electronic device 100 for the inductive coupling scheme applicable to the embodiments disclosed in this specification will be described in detail.

FIGS. 7 and 8 are block diagrams illustrating partial configurations of the wireless power transmission apparatus 200 and the electronic device 100 for an electromagnetic induction scheme applicable to the embodiments disclosed in this specification.

The configuration of the power transmission unit 280 included in the wireless power transmission apparatus 200 will be described below with reference to FIG. 7, and the configuration of the power supply unit 180 included in the electronic device 100 will be described below with reference to FIG. 8.

Referring to FIG. 7, the power conversion unit 281 of the wireless power transmission apparatus 200 may be configured to include the transmission coil (Tx coil) 2811a and an inverter 2812.

The transmission coil 2811a generates a magnetic field corresponding to a wireless power signal depending on a change in current. In some embodiments, the transmission coil 2811a may be implemented as a planar spiral type. In addition, in some embodiments, the transmission coil 2811a may be implemented as a cylindrical solenoid type.

The inverter 2812 inverts a DC input obtained from the power supply unit 260 into an AC waveform. The alternating current inverted by the inverter 2812 drives a resonant circuit including the transmission coil 2811a and a capacitor (not shown), so that a magnetic field may be generated in the transmission coil 2811a.

In addition, the power conversion unit 281 may be configured to further include a positioning unit 2814. The positioning unit 2814 may move or rotate the transmission coil 2811a to increase the efficiency of the wireless power transmission by the inductive coupling scheme. This is because, as described above, the power transmission by the inductive coupling scheme has a dependence on the alignment of and the distance between the wireless power transmission apparatus 200, including the primary and secondary coils, and the electronic device 100. Particularly, the positioning unit 2814 may be used when the electronic device 100 is not present in the active area of the wireless power transmission apparatus 200.

Accordingly, the positioning unit 2814 may be configured to include a driving unit (not shown), wherein the driving unit may move the transmission coil 2811a of the wireless power transmission apparatus 200 such that the distance between a center of the transmission coil 2811a and a center of the reception coil 1811a of the electronic device 100 is within a certain range, or may rotate the transmission coil 2811a such that the center of the transmission coil 2811a and the center of the reception coil 1811a overlap.

To this end, the wireless power transmission apparatus 200 may further include a position detection unit (not shown) configured to include a sensor for detecting a position of the electronic device 100, and the power transmission control unit 282 may control the positioning unit 2814 based on position information on the electronic device 100 received from the position detection unit.

In addition, to this end, the power transmission control unit 282 may receive control information on the alignment or the distance to the electronic device 100 through a modulation/demodulation unit 283, and control the positioning unit 2814 based on the received control information on the alignment or the distance.

If the power conversion unit 281 is configured to include a plurality of transmission coils, the positioning unit 2814 may determine which of the plurality of transmission coils is to be used to transmit the power.

In addition, the power conversion unit 281 may be configured to further include a power sensing unit 2815. The power sensing unit 2815 of the wireless power transmission apparatus 200 monitors current or voltage flowing through the transmission coil 2811a. The power sensing unit 2815 is for checking whether the wireless power transmission apparatus 200 is operating normally, and may detect the voltage or the current of the power supplied from the outside and check whether the detected voltage or current exceeds a threshold value. Although not shown, the power sensing unit 2815 may include a resistor for detecting the voltage or the current of the power supplied from the outside, and a comparator for comparing the detected voltage value or current value of the power with a threshold value, and outputting a comparison result. Based on the check result of the power sensing unit 2815, the power transmission control unit 282 may control a switching unit (not shown) so as to cut off the power applied to the transmission coil 2811a.

Referring to FIG. 8, the power supply unit 180 of the electronic device 100 may be configured to include the reception coil (Rx coil) 1811a and a rectification circuit 1813.

The current is induced in the reception coil 1811a depending on a change in the magnetic field generated from the transmission coil 2811a. The type of the reception coil 1811a may be the planar spiral type or the cylindrical solenoid type according to the embodiments, as in the case of the transmission coil 2811a.

In addition, serial/parallel capacitors may be configured to be connected to the reception coil 1811a to increase the reception efficiency of the wireless power or to detect a resonance.

The reception coil 1811a may be a single coil type or a plurality of coils type. The rectification circuit 1813 performs a full-wave rectification on the current to convert the alternating current into a direct current. The rectification circuit 1813 may be implemented, for example, as a full bridge rectification circuit including four diodes, or a circuit using active components.

In addition, the rectification circuit 1813 may further include a regulator so as to make the rectified current into a more flat and stable direct current. In addition, the output power of the rectification circuit 1813 is supplied to the respective components of the power supply unit 180. In addition, the rectification circuit 1813 may further include a DC-DC converter to convert its output DC power into an appropriate voltage to correspond to the power required for the respective components of the power supply unit 180 (for example, a circuit such as the charging unit 188).

The modulation/demodulation unit 183 may be connected to the power reception unit 181, may be composed of a resistive element having a resistance varying depending on the direct current, and may be composed of a capacitive element having a reactance varying depending on the alternating current. The power reception control unit 182 may modulate the wireless power signal received at the power reception unit 181 by changing the resistance or the reactance of the modulation/demodulation unit 183.

The power supply unit 180 may also be configured to further include a power sensing unit 1814. The power sensing unit 1814 of the electronic device 100 monitors the voltage and/or the current of the power rectified by the rectification circuit 1813, and when the monitoring result indicates that the voltage and/or the current of the rectified power exceeds a threshold value, the power reception control unit 182 transmits a power control message to the wireless power transmission apparatus 200 so as to cause the wireless power transmission apparatus 200 to transmit an appropriate power.

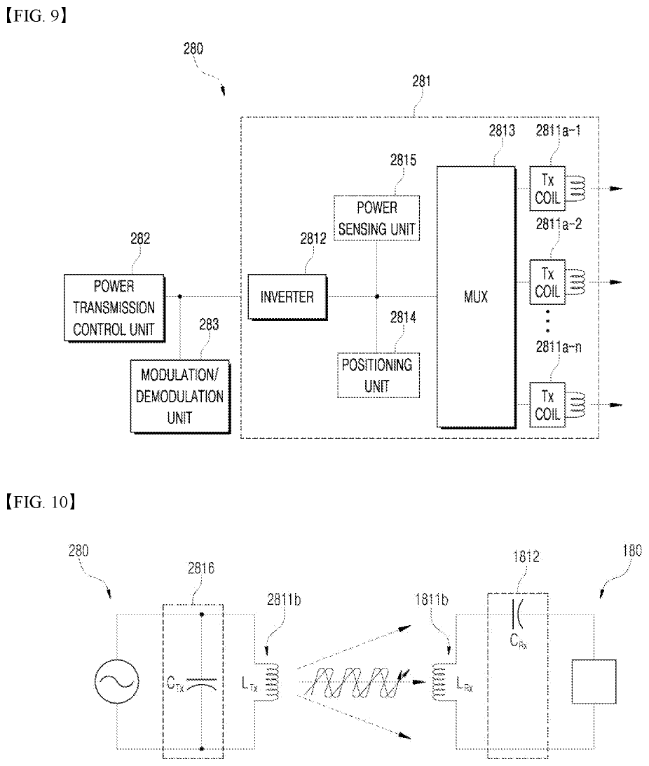

FIG. 9 is a block diagram of the wireless power transmission apparatus 200 configured to include one or more transmission coils for transmitting the power in the inductive coupling scheme applicable to the embodiments disclosed in this specification.

Referring to FIG. 9, the power conversion unit 281 of the wireless power transmission apparatus 200 according to the embodiments disclosed in this specification may be composed of one or more transmission coils 2811a-1 to 2811a-n. The one or more transmission coils 2811a-1 to 2811a-n may be an array of partly overlapping primary coils.

The active area may be determined by some of the one or more transmission coils. The one or more transmission coils 2811a-1 to 2811a-n may be mounted below the interface surface. In addition, the power conversion unit 281 may further include a multiplexer 2813 for establishing and releasing connections of some of the one or more transmission coils 2811a-1 to 2811a-n.

When the position of the electronic device 100 on the interface surface is detected, the power transmission control unit 282 may control the multiplexer 2813 such that some of the one or more transmission coils 2811a-1 to 2811a-n which may establish the inductive coupling relationship with the reception coil 1811a of the electronic device 100 in view of the detected position of the electronic device 100 may be connected to the reception coil 1811a.

To this end, the power transmission control unit 282 may obtain the position information on the electronic device 100. In some embodiments, the power transmission control unit 282 may obtain the position information on the electronic device 100 on the interface surface through a position sensing unit (not shown) provided in the wireless power transmission apparatus 200. In still other embodiments, the power transmission control unit 282 may receive, from an object on the interface surface and by using each of the one or more transmission coils 2811a-1 to 2811a-n, a power control message indicating an intensity of a wireless power signal or a power control message indicating identification information on the object, and may obtain the position information on the electronic device 100 by determining which of the one or more transmission coils is close to the electronic device 100 based on the received result.

The active area may also be a part of the interface surface, and may refer to a part where the magnetic field may pass through with high efficiency when the wireless power transmission apparatus 200 transmits the power to the electronic device 100. In this case, a single transmission coil or a combination of one or more transmission coils, which generates the magnetic field passing through the active area, may be referred to as a primary cell. Accordingly, the power transmission control unit 282 may determine the active area based on the detected position of the electronic device 100, and may control the multiplexer 2813 such that the multiplexer 2813 establishes a connection of the primary cell corresponding to the active area and allows the coils belonging to the primary cell to establish the inductive coupling relationship with the reception coil 1811a of the electronic device 100.

When one or more electronic devices 100 are disposed on the interface surface of the wireless power transmission apparatus 200 configured to include the one or more transmission coils 2811a-1 to 2811a-n, the power transmission control unit 282 may also control the multiplexer 2813 such that each of the coils belonging to the primary cell corresponding to the position of each of the electronic devices establishes the inductive coupling relationship. Accordingly, the wireless power transmission apparatus 200 may transmit the power wirelessly to one or more electronic devices by generating the wireless power signals using different coils.

In addition, the power transmission control unit 282 may be set such that power having different characteristics is supplied to each of the coils corresponding to the electronic devices. In this case, the wireless power transmission apparatus 200 may transmit the power by setting different power transmission methods, efficiency, characteristics, and the like for each electronic device.

The power conversion unit 281 may further include an impedance matching unit (not shown) for adjusting the impedance to form a resonant circuit together with the coils connected thereto.

FIGS. 10 to 13 disclose how the wireless power transmission apparatus transmits the power according to the embodiments that support the resonant coupling scheme.

FIG. 10 illustrates the concept of transmitting the power wirelessly from the wireless power transmission apparatus to the electronic device according to the embodiments that support the resonant coupling scheme.

First, resonance will be briefly described. The resonance refers to a phenomenon in which a vibrometer periodically receives an external force having the same frequency as its natural frequency and has a distinctly increasing amplitude. The resonance is a phenomenon that occurs in all vibrations, including mechanical vibrations, electrical vibrations, and the like. In general, when a force capable of vibrating the vibrometer is applied to the vibrometer from the outside, if the natural frequency of the vibrometer is equal to the frequency of the force applied from the outside, its vibration and amplitude become large.

In terms of the same principle, when a plurality of vibrating bodies separated within a certain distance vibrate at the same frequency, the plurality of vibrating bodies resonate with each other, and in this case, the resistance between the plurality of vibrating bodies decreases. In an electric circuit, an inductor and a capacitor may be used to make a resonant circuit.

When the power transmission of the wireless power transmission apparatus 200 is based on the resonant coupling scheme, a magnetic field having a specific vibration frequency due to AC power is generated in the power transmission unit 280. When the resonance phenomenon occurs in the electronic device 100 due to the generated magnetic field, power is generated in the electronic device 100 by the resonance phenomenon.

For the principle of the resonant coupling scheme, generally, a method of generating an electromagnetic wave to transmit power may have a low power transmission efficiency, and may adversely affect the human body due to the radiation of the electromagnetic wave and exposure to the electromagnetic wave.

However, as described above, when the plurality of vibrating bodies resonate electromagnetically with each other, the power transmission efficiency can be very high because there is no influence of surrounding objects other than the plurality of vibrating bodies. An energy tunnel may be generated between the plurality of vibrating bodies that resonates electromagnetically with each other in this manner. This may be referred to as an energy coupling or an energy tail.

The resonant coupling scheme disclosed in this specification may use the electromagnetic wave having a low frequency, and when the power is transmitted using the electromagnetic wave having the low frequency, only a magnetic field affects an area located within a single wavelength of the electromagnetic wave. This may be referred to as a magnetic coupling or a magnetic resonance. This magnetic resonance may be generated when the wireless power transmission apparatus 200 and the electronic device 100 are located within the single wavelength of the electromagnetic wave having the low frequency.

In this case, since the human body is generally sensitive to an electric field and not sensitive to a magnetic field, transmission of the power using the magnetic resonance can reduce adverse effects of the human body due to exposure to the electromagnetic wave. In addition, the energy tail is generated due to the resonance phenomenon, and thus the power transmission is of a non-radiative type. For this reason, transmission using the electromagnetic wave can solve the problems associated with radiation that may often occur in transmitting power.

The resonant coupling scheme may be a method of transmitting the power using the electromagnetic wave having the low frequency as described above. Therefore, the transmission coil 2811b of the wireless power transmission apparatus 200 may, in principle, generate the magnetic field or the electromagnetic wave to transmit the power. However, an aspect of magnetic resonance, that is, an aspect of the transmission of the power by the magnetic field, will be described below with respect to the resonant coupling scheme.

The resonance frequency may be determined by, for example, an equation such as Equation 1 below:

$$f = \frac{1}{2 π \sqrt{LC}} \qquad [ Equation 1 ]$$

In Equation 1, the resonance frequency f is determined by an inductance L and a capacitance C in the circuit. In the circuit for generating the magnetic field using a coil, the inductance may be determined by, for example, the number of turns of the coil, and the capacitance may be determined by, for example, an interval or an area between the coils. A capacitive resonance generating circuit may be connected in addition to the coil to determine the resonance frequency.

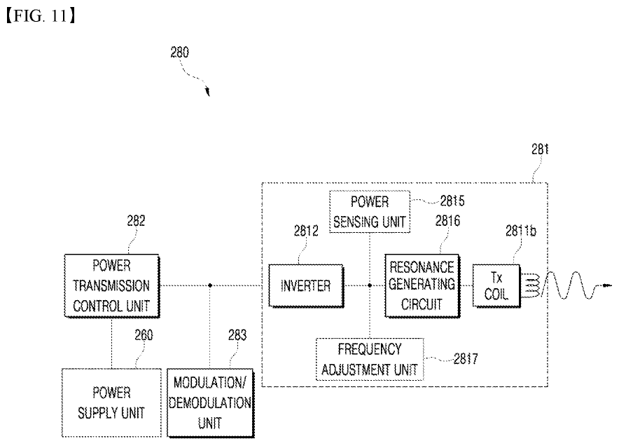

Referring to FIG. 11, in the embodiments in which the power is transmitted wirelessly in the resonant coupling scheme, the power conversion unit 281 of the wireless power transmission apparatus 200 may be configured to include the transmission coil (Tx coil) 2811b which generates the magnetic field, and a resonance generating circuit 2816 which is connected to the transmission coil 2811b and determines a specific vibration frequency. The resonance generating circuit 2816 may be implemented using capacitors, and the specific vibration frequency may be determined based on the inductance of the transmission coil 2811b and the capacitance of the resonance generating circuit 2816.

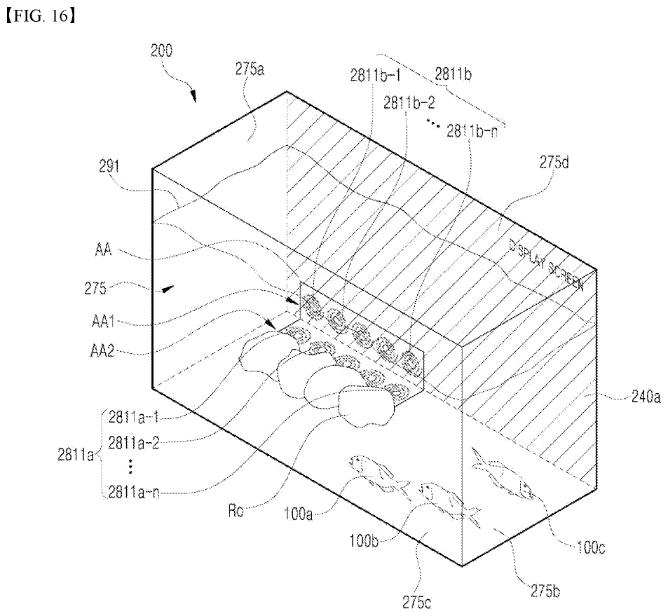

A circuit element in the resonance generating circuit 2816 may be configured in various ways such that the power conversion unit 281 may generate the magnetic field, and is not limited to the configuration in which it is connected in parallel with the transmission coil 2811b as shown in FIG. 16.

In addition, the power reception unit 181 of the electronic device 100 includes a reception coil (Rx coil) 1811b, and a resonance generating circuit 1812 configured to generate the resonance phenomenon by means of the magnetic field generated in the wireless power transmission apparatus 200. The power reception unit 181 comprises at least one of a power receiver or consists of at least one of a power receiver.

That is, the resonance generating circuit 1812 may also be implemented using capacitors, and the resonance generating circuit 1812 may be configured such that the resonance frequency determined based on the inductance of the reception coil 1811b and the capacitance of the resonance generating circuit 1812 is equal to the resonance frequency of the generated magnetic field.

The configuration of a circuit element in the resonance generating circuit 1812 may be configured in various ways such that the power reception unit 181 may resonate due to the magnetic field, and is not limited to the configuration in which it is connected in series with the reception coil 1811b as shown in FIG. 10.

The specific vibration frequency of the wireless power transmission apparatus 200 may be obtained using Equation 1 with LTx and CTx. Here, when the result of applying LRX and CRX of the electronic device 100 to Equation 1 is equal to the specific vibration frequency, the resonance occurs in the electronic device 100.

According to the embodiments that support the wireless power transmission method by means of the resonant coupling, since an electromagnetic wave is transmitted through the near field electromagnetic field when the wireless power transmission apparatus 200 and the electronic device 100 resonate at the same frequency, there is no energy transmission for a predetermined period of time if the frequencies are different.

Accordingly, as compared with the inductive coupling scheme, the efficiency of the wireless power transmission by means of the resonant coupling scheme has a great dependence on the frequency characteristic, but has a relatively small dependence on the alignment and the distance between the wireless power transmission apparatus 200 and the electronic device 100, each including the coil.

Hereinafter, the configurations of the wireless power transmission apparatus and the electronic device for the resonant coupling scheme applicable to the embodiments disclosed in this specification will be described below in detail.

FIG. 11 is a block diagram illustrating a partial configuration of the wireless power transmission apparatus 200 and the electronic device 100 for the resonant scheme applicable to the embodiments disclosed in this specification.

The configuration of the wireless power transmission unit 280 included in the wireless power transmission apparatus 200 will be described below with reference to FIG. 11. The power conversion unit 281 of the wireless power transmission apparatus 200 may be configured to include the transmission coil (Tx coil) 2811b, the inverter 2812, and the resonance generating circuit 2816. The inverter 2812 may be configured to be connected to the transmission coil 2811b and the resonance generating circuit 2816.

The transmission coil 2811b may be mounted separately from the transmission coil 2811a for transmitting the power in the inductive coupling scheme, but it is possible to transmit the power in both the inductive coupling scheme and the resonant coupling scheme by using only a single coil.

The transmission coil 2811b generates the magnetic field for transmitting the power, as described above. The transmission coil 2811b and the resonance generating circuit 2816 may vibrate when the AC power is applied thereto, and at this time, the vibration frequency may be determined based on the inductance of the transmission coil 2811b and the capacitance of the resonance generating circuit 2816.

To this end, the inverter 2812 inverts the DC input received from the power supply unit 260 into the AC waveform, and the inverted AC current is applied to the transmission coil 2811b and the resonance generating circuit 2816.

In addition, the power conversion unit 281 may be configured to further include a frequency adjustment unit 2817 for changing the resonance frequency value of the power conversion unit 281. Since the resonance frequency of the power conversion unit 281 is determined according to Equation 1 based on the inductance and the capacitance in the circuit constituting the power conversion unit 281, the power transmission control unit 282 may determine the resonance frequency of the power conversion unit 281 by controlling the frequency adjustment unit 2817 so as to change the inductance and/or the capacitance.

In some embodiments, the frequency adjustment unit 2817 may be configured to include a motor that may change the capacitance by adjusting a distance between capacitors included in the resonance generating circuit 2816. In addition, in some embodiments, the frequency adjustment unit 2817 may be configured to include the motor that may change the inductance by adjusting the number of turns or a diameter of the transmission coil 2811b. In addition, in some embodiments, the frequency adjustment unit 2817 may be configured to include active elements that determine the capacitance and/or the inductance.

The power conversion unit 281 may also be configured to further include the power sensing unit 2815. The operation of the power sensing unit 2815 is the same as described above.

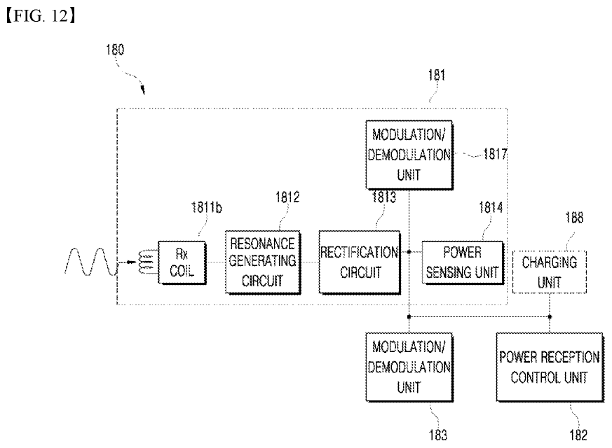

The configuration of the power supply unit 180 included in the electronic device 100 will be described below with reference to FIG. 12. The power supply unit 290 may be configured to include the reception coil (Rx coil) 1811b and the resonance generating circuit 1812, as described above.

In addition, the power reception unit 181 of the power supply unit 180 may be configured to further include the rectification circuit 1813 that converts the alternating current generated by the resonance phenomenon into the direct current. The rectification circuit 1813 may be configured in the same manner as described above.

In addition, the power reception unit 181 may be configured to further include the power sensing unit 1814 that monitors the voltage and/or the current of the rectified power. The power sensing unit 1814 may be configured in the same manner as described above.

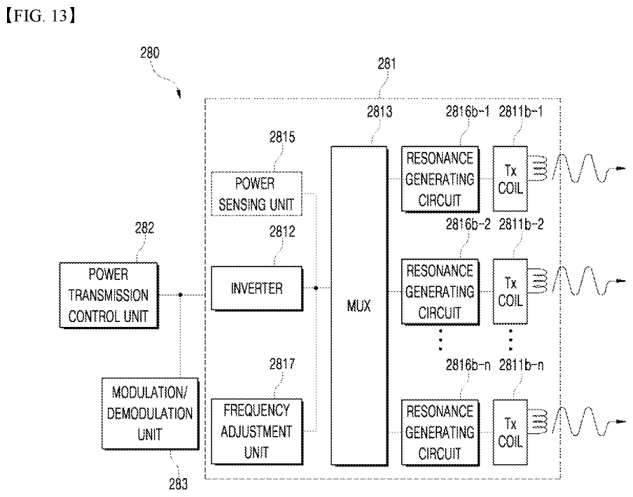

FIG. 13 is a block diagram of the wireless power transmission apparatus configured to include one or more transmission coils for transmitting the power according to the embodiments that support the resonant coupling scheme.

Referring to FIG. 13, the power conversion unit 281 of the wireless power transmission apparatus 200 according to the embodiments disclosed in this specification may be configured to include one or more transmission coils 2811b-1 to 2811b-n, and resonance generating circuits 2816-1 to 2816-n connected to each of the transmission coils. In addition, the power conversion unit 281 may further include the multiplexer 2813 for establishing and releasing the connections of some of the one or more transmission coils 2811b-1 to 2811b-n.

The one or more transmission coils 2811b-1 to 2811b-n may be set to have the same resonance frequency. In some embodiments, some of the one or more transmission coils 2811b-1 to 2811b-n may be set to have different resonance frequencies, which are determined depending on what inductance and/or capacitance the resonance generation circuits 2816-1 to 2816-n that are connected to the one or more transmission coils 2811b-1 to 2811b-n respectively have.

When one or more electronic devices 100 are disposed in the active area or the sensing area of the wireless power transmission apparatus 200 configured to include the one or more coils 2811b-1 to 2811b-n, the power transmission control unit 282 may also control the multiplexer 2813 such that each of electronic devices establishes a different resonant coupling relationship. Accordingly, the wireless power transmission apparatus 200 may transmit the power wirelessly to one or more electronic devices by generating the wireless power signal using different coils.

In addition, the power transmission control unit 282 may be set such that the power having different characteristics is supplied to the coils corresponding to the electronic devices. In this case, the wireless power transmission apparatus 200 may transmit the power by setting different power transmission methods, resonance frequency, efficiency, characteristic, and the like for each electronic device.

To this end, the frequency adjustment unit 2817 may be configured to change the inductances and/or capacitances of the resonant generating circuits 2816-1 to 2816-n which are connected to the one or more transmission coils 2811b-1 to 2811b-n respectively.

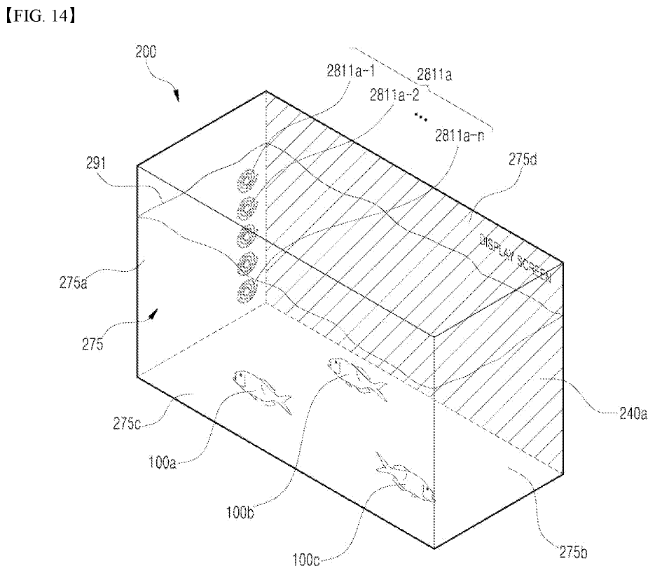

FIGS. 14 to 19 are views showing the display apparatus 200 having the water tank on which the transmission coils are arranged, according to various embodiments of the present disclosure.

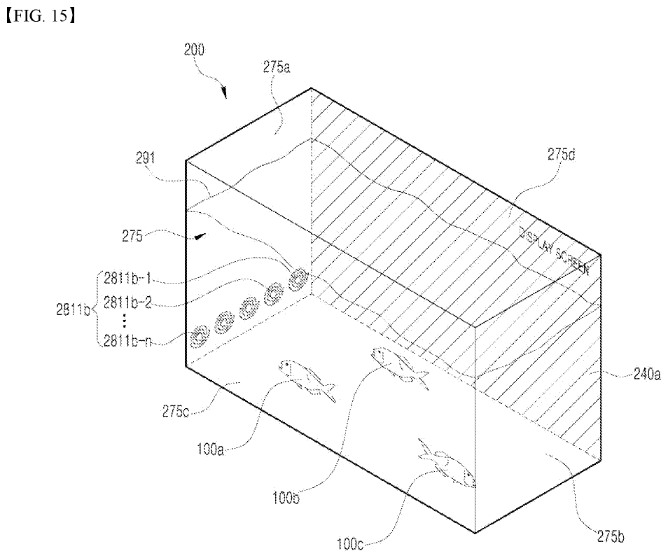

FIG. 14 shows that the transmission coils are arranged in a row in the vertical direction according to one embodiment of the present disclosure, and FIG. 15 shows that the transmission coils are arranged in a row in the horizontal direction according to one embodiment of the present disclosure.

The display apparatus 200 may include a plurality of transmission coils 2811a-1 to 2011a-n which are located on the inner wall of the water tank 275 and arranged in a predetermined pattern. The inner wall may include an interior of the wall that receives the material (including water) contained in the water tank 275. The transmission coils 2811a-1 to 2011a-n may be included in the wireless power transmission unit 280.

The transmission coils 2811a-1 to 2011a-n may be arranged in a predetermined pattern, for example, in the vertical direction (FIG. 14), the horizontal direction (FIG. 15), or a diagonal direction on a particular inner wall, but the embodiments of the arrangement are not limited to these.

When the swimming robot 100 approaches to within a charging range of the wireless power transmission unit 280, the control module 290 may transmit wireless power to the swimming robot 100 through the transmission coils 2811a-1 to 2011a-n.

Specifically, the control module 290 may select a transmission coil to transmit the wireless power to the swimming robot 100, and may control the wireless power transmission unit 280 such that control the wireless power transmission unit 280 transmits the wireless power to the reception coil of the swimming robot 100 using the selected transmission coil.

When the swimming robot 100 is within the charging range of the wireless power transmission unit 280, the control module 290 may control the wireless power transmission unit 280 such that the wireless power transmission unit 280 transmits the wireless power to the reception coil of the swimming robot 100 while changing the transmission coil based on the moving direction of the swimming robot 100. That is, the control module 290 may transmit the wireless power to the reception coil of the swimming robot 100 moving vertically or horizontally, based on the coil arrangement direction.

Each of the transmission coils 2811a-1 to 2011a-n shown in FIG. 14 may be the coil to which the magnetic induction scheme is applied, and each of the transmission coils 2811b-1 to 2011b-n shown in FIG. 15 may be the coil to which the magnetic resonance scheme is applied.

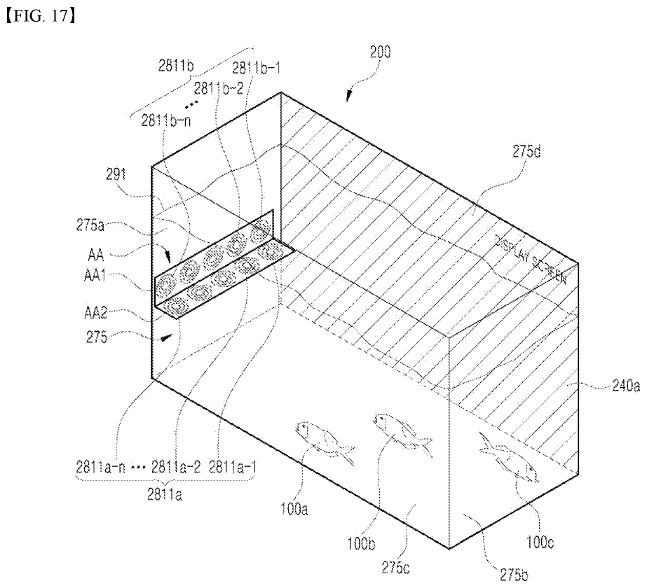

FIGS. 16 and 17 show the display apparatus 200 having the water tank with a first charging surface and a second charging surface according to one embodiment of the present disclosure.

The display apparatus 200 may include a first charging surface AA1 having the plurality of transmission coils arranged in a row in a horizontal direction on one surface of the inner wall of the water tank, and a second charging surface AA2 abutting against the first charging surface AA1 and extending to protrude from the first charging surface AA1 to the inside of the water tank.

The second charging surface AA2 may be disposed on a bottom surface 275c of the water tank (FIG. 16), but may also be disposed on another surface of the water tank (FIG. 17).

Some 2811b of the plurality of transmission coils arranged on the display apparatus 200 may be arranged in a row in the horizontal direction on the first charging surface AA1, and some 2811a of the plurality of transmission coils may be arranged in a row in the horizontal direction on the second charging surface AA2 in order to support the swimming robot 100 thereon. That is, even when the swimming robot 100 is discharged, the wireless power transmission unit 280 may transmit the wireless power to the swimming robot 100 using the transmission coils 2811a arranged on the second charging surface AA2.

The transmission coils 2811a arranged on the second charging surface AA2 may transmit the wireless power in a direction toward an upper part of the water tank 275 (for example, in a direction opposite to the direction of gravity), and the second charging surface AA2 may extend in a direction perpendicular to the first charging surface AA1 but may extend at any angle capable of supporting the swimming robot 100 thereon, according to the embodiment.

Here, the transmission coils 2811b arranged on the first charging surface AA1 may transmit the wireless power in the magnetic resonance scheme, and the transmission coils 2811a arranged on the second charging surface AA2 may transmit the wireless power in the magnetic induction scheme.

In addition, the display apparatus 200 may have a structure (Ro in FIG. 16) for preventing the user from seeing the charging of the swimming robot 100.

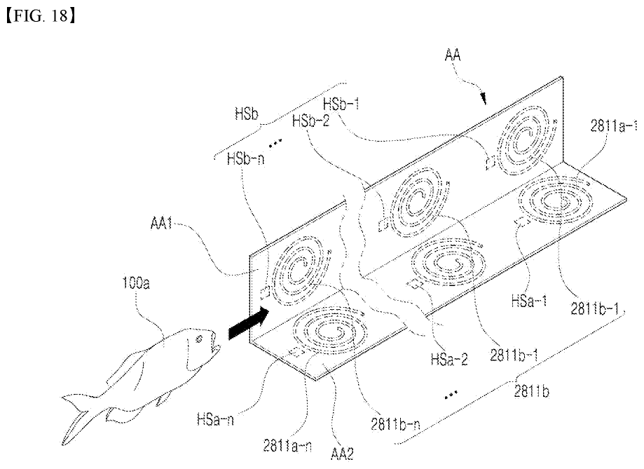

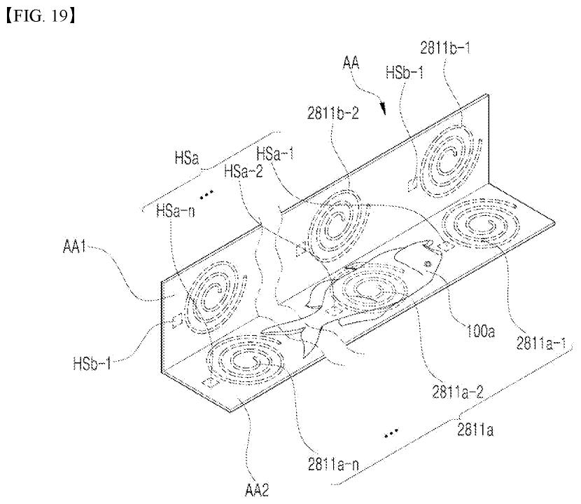

When the swimming robot 100 swims and enters the charging range of the wireless power transmission unit 280, the control module 290 may transmit power to a power reception unit of the swimming robot 100 using the magnetic resonance scheme that has a smaller dependence on the distance than the magnetic induction scheme (FIG. 18). The control module 290 may preferentially apply the magnetic resonance scheme when the amount of charge of the swimming robot 100 is higher than a first set value, and may preferentially transmit the power to the power reception unit of the swimming robot 100 in the magnetic induction scheme when the amount of charge of the swimming robot 100 is lower than a second set value lower than the first set value. When the amount of charge of the swimming robot 100 is lower than the second set value, the control module 290 may control the swimming robot 100 to move to contact the transmission coil such that the reception coil of the swimming robot 100 is aligned with the transmission coil. For example, the control module 290 may control the swimming robot 100 such that the belly of the swimming robot 100 contacts the transmission coil (FIG. 19).

In addition, the control module 290 may receive information on the amount of charge of the swimming robot 100 through the communication unit 210 in real time, may detect an internal characteristic (for example, current, voltage, or power) of the swimming robot 100 by transmitting the wireless power in the magnetic induction scheme or the magnetic resonance scheme when the swimming robot 100 enters the charging range of the wireless power transmission unit 280, may perform the wireless charging in the most suitable scheme (for example, the scheme providing the greatest power intensity), and may further select the most suitable transmission coil.

Accordingly, when the swimming robot 100 approaches to within the charging range of the wireless power transmission unit 280, the control module 290 may determine whether to transmit the wireless power using the transmission coils 2811b arranged on the first charging surface AA1 or transmit the wireless power using the transmission coils 2811a arranged on the second charging surface AA2.

The sensing unit 230 of the display apparatus 200 may include a plurality of Hall sensors 235. At least one of the Hall sensors 235 may correspond to one transmission coil, and may thereby recognize the swimming robot 100 approaching each of the transmission coils.

Since the multiplexer 2813 is included in the wireless power transmission unit 280, the display apparatus 200 may cause only a specific transmission coil to transmit the wireless power. The display apparatus 200 may thus detect a change in the internal characteristic of the swimming robot 100 when the transmission coil transmits the wireless power, receive information on the internal characteristic from the swimming robot 100b, and thereby select the most suitable transmission coil.

When the control module 290 determines to transmit the wireless power using the transmission coils 2811a arranged on the second charging surface AA2, the control module 290 may select the transmission coil of the second charging surface AA2 aligned with the reception coil of the swimming robot 100 and transmit the wireless power to the reception coil using the selected transmission coil.

The control module 290 may monitor in real time the swimming robot 100 requiring wireless charging, and may control the swimming robot 100 requiring wireless charging such that the swimming robot 100 requiring wireless charging enters the charging range of the wireless power transmission unit 280.

When the swimming robot 100 located in the water tank 275 enters the charging range of the wireless power transmission unit 280, the swimming robot 100 may swim such that the swimming robot 100 remains in the charging range for a predetermined time. The control module 190 of the swimming robot 100 may monitor the amount charge by itself, and may control the swimming structure unit 160 such that the swimming robot 100 contacts the transmission coil arranged on the second charging surface AA2 when the swimming robot 100 requires a lot of charging.

The swimming robot 100 may include both an induction coil for receiving the wireless power in the magnetic induction scheme and a resonance coil for receiving the wireless power in the magnetic resonance scheme, and one reception coil may also be configured to drive in both the magnetic induction scheme and the magnetic resonance scheme.

The control module 190 of the swimming robot 100 may detect the internal characteristic of the power reception unit, select the induction coil or the resonance coil based on the internal characteristic, and control the power reception unit such that the power reception unit receives the wireless power through the selected coil. Here, the internal characteristic may be one of a voltage value, a current value and a power value, and may be detected in the case of both the alternating current and the direct current.

In addition, the swimming robot 100 may monitor the amount of charge of wireless power by itself, and move into the charging range of the wireless power transmission unit 280 when the amount of charge of the battery is equal to or less than a predetermined value.

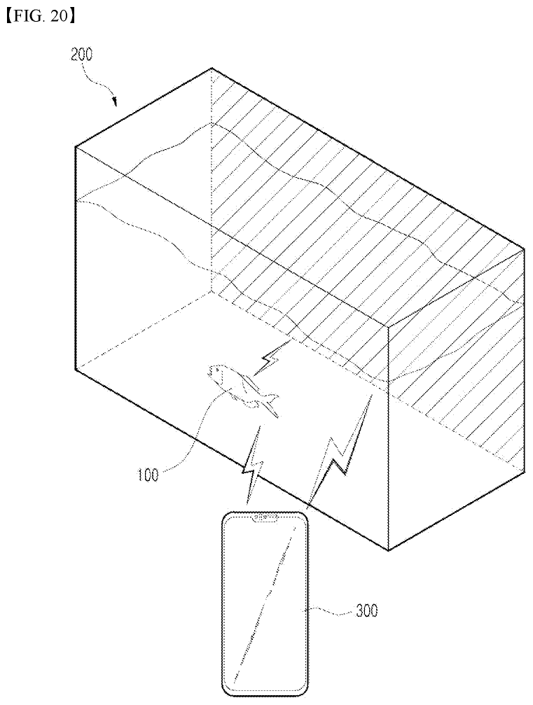

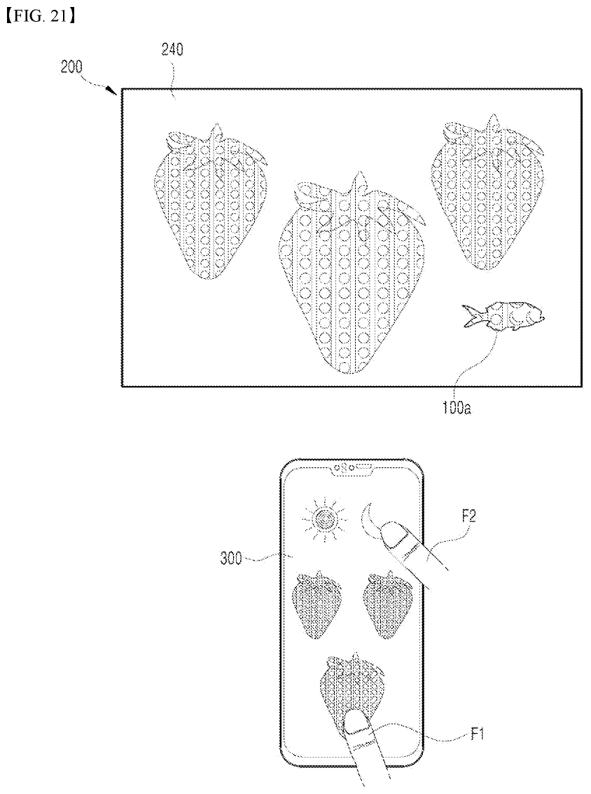

FIGS. 20 and 21 are views showing the display apparatus 200 having the water tank capable of interacting with both the swimming robot and the mobile terminal, according to one embodiment of the present disclosure.

The display apparatus 200 may communicate with the mobile terminal 300 within the control range of the user, and reflect an event generated on the mobile terminal 300 on the display 240.

First, the control module 290 of the display apparatus 200 may receive information on a specific video displayed on the mobile terminal 300 through the communication unit 210, and display the specific video on the display 240. Here, the resolution of the video displayed by the display apparatus 200 and the resolution of the video displayed on the mobile terminal 300 may be adjusted so as to correspond to each other.

When the control module 290 of the display apparatus 200 receives one or more pieces of video feature information on a specific video displayed on the mobile terminal 300, from the mobile terminal 300 and through the communication unit 210, the control module 290 may control the swimming robot 100 such that the swimming robot 100 applies the video feature information.

That is, the display apparatus 200 may apply the event generated on the mobile terminal 300 as it is. For example, when several parts of the specific video are selected by a touch input of the user on the mobile terminal 300, the display apparatus 200 may allow the swimming robot 100 to apply the several parts as they are (FIG. 21).

Likewise, when the specific item is selected on the mobile terminal 300, the display apparatus 200 may allow the specific item to be displayed on the display 240, and may allow all of the color information, the shape information, the form information, and the pattern information selected on the mobile terminal 300 to be applied on the display 240.

The present disclosure described above may be embodied as computer-readable code on a computer-readable medium. The computer-readable medium includes any type of recording device capable of storing data which may be read by a computer system. Examples of the computer-readable medium include a hard disk drive (HDD), a solid state disk (SSD), a silicon disk drive (SDD), a ROM, a RAM, a CD-ROM, a magnetic tape, a floppy disk, an optical data storage device, and the like, and the computer may include a control module 190 of the swimming robot 100 or the control module 290 of the display apparatus 200.

Although specific embodiments of the present disclosure have been shown and described above, the present disclosure is not limited to the specific embodiments described, and those skilled in the art will appreciate that various modification and changes may be made therein, without departing from the scope and spirit of the present disclosure. Therefore, the scope of the present disclosure should not be limited by the embodiments described but should be determined by the technical idea described in the claims.

What is claimed is:

1. A display apparatus having a water tank in which one or more swimming robots are located, comprising:
a communicator configured to communicate with the swimming robot or a mobile terminal;
a display configured to display a video;
one or more sensors;
a wireless power transmitter which is located on an inner wall of the water tank and which includes a plurality of arranged transmission coils; and
a controller,
wherein when the swimming robot enters a charging range of the wireless power transmitter, the controller selects a transmission coil to transmit wireless power to the swimming robot, and controls the wireless power transmitter such that the wireless power transmitter transmits the wireless power to a reception coil of the swimming robot using the selected transmission coil.

2. The display apparatus according to claim 1,
wherein the transmission coils are arranged in a row in a vertical direction or a horizontal direction on one surface of the inner wall of the water tank, and
wherein the controller is configured to control the wireless power transmitter such that the wireless power transmitter transmits the wireless power to the reception coil of the swimming robot while changing the transmission coil based on a moving direction of the swimming robot.

3. The display apparatus according to claim 1,
wherein the wireless power transmitter comprises:
a first charging surface which is disposed on one surface of the inner wall of the water tank and on which some of the plurality of transmission coils are arranged, and
a second charging surface on which some of the plurality of transmission coils are arranged and which abuts against the first charging surface and extends to protrude from the first charging surface to the inside of the water tank in order to support the swimming robot thereon, and
wherein the transmission coils arranged on the first charging surface are arranged in a row in a horizontal direction.

4. The display apparatus according to claim 3,
wherein the transmission coils arranged on the second charging surface are arranged in a row in the horizontal direction and transmit the wireless power in a direction toward an upper part of the water tank.

5. The display apparatus according to claim 3,
wherein the controller is configured to:
control the wireless power transmitter such that the transmission coils arranged on the first charging surface transmit the wireless power in a magnetic resonance scheme, and
control the wireless power transmitter such that the transmission coils arranged on the second charging surface transmit the wireless power in a magnetic induction scheme.

6. The display apparatus according to claim 5,
wherein when the swimming robot enters the charging range, the controller determines whether to transmit the wireless power using the transmission coils arranged on the first charging surface or transmit the wireless power using the transmission coils arranged on the second charging surface, based on power intensity information received from the swimming robot through the communicator.

7. The display apparatus according to any one of claim 1,
wherein the sensor includes a Hall sensor corresponding to the transmission coils, and
wherein the controller is configured to detect a moving direction of the swimming robot through the Hall sensor.

8. The display apparatus according to claim 6,
wherein when the controller determines to transmit the wireless power using the transmission coils arranged on the second charging surface, the controller selects the transmission coil on the second charging surface aligned with the reception coil of the swimming robot, and controls the wireless power transmitter such that the wireless power transmitter transmits the wireless power to the reception coil using the selected transmission coil.

9. The display apparatus according to claim 1,
wherein the controller is configured to monitor the swimming robot through the communicator, and control the swimming robot such that the swimming robot enters the charging range of the wireless power transmitter when an amount of charge of the swimming robot is equal to or less than a predetermined value.

10. A swimming robot located in a water tank of a display apparatus, comprising:
a communicator configured to communicate with the display apparatus or a mobile terminal;
one or more sensors configured to detect a user behavior or an event occurring on the display apparatus;
an inputter for inputting a video signal or an audio signal;
a swimming structure configured to drive movement of the swimming robot in water;
an outputter;
a power supplier including a power receiver; and
a controller,
wherein when an amount of charge of a battery of the power suppler is equal to or less than a predetermined value, the controller controls the swimming robot such that the swimming robot enters a charging range of a wireless power transmitter of the water tank and swims within the charging range for a predetermined time.

11. A swimming robot located in a water tank of a display apparatus, comprising:
a communicator configured to communicate with the display apparatus or a mobile terminal;
one or more sensors configured to detect a user behavior or an event occurring on the display apparatus;
an inputter for inputting a video signal or an audio signal;
a swimming structure configured to drive movement of the swimming robot in water;
an outputter;
a power supplier including a power receiver; and
a controller,
wherein when the controller receives an instruction to enter a charging range of a wireless power transmitter of the water tank from the display apparatus through the communicator, the controller controls the swimming robot such that the swimming robot enters the charging range of the wireless power transmitter of the water tank and swims within the charging range for a predetermined time.

12. The swimming robot according to claim 11,
wherein the power receiver includes an induction coil for receiving wireless power in a magnetic induction scheme and a resonance coil for receiving wireless power in a magnetic resonance scheme, and
wherein the controller is configured to:
detect an internal characteristic of the power receiver,
select the induction coil or the resonance coil based on the internal characteristic, and
control the power receiver such that the power receiver receives the wireless power through the selected coil.

13. The swimming robot according to claim 12,
wherein the internal characteristic is information based on at least one of voltage, current, or power measured by the power receiver.
